(19) United States
(12) Patent Application Publication
(10) Pub. No.: US 2005/0260969 A1
(43) Pub. Date: Nov. 24, 2005

(54) Portable radio receiver and automatic power generator

(75) Inventors: Yoshiki Nagata, Kariya-shi (JP); Hironori Ito, Kariya-shi (JP); Akira Yokoi, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki, Kariya-shi (JP)

(21) Appl. No.: 11/133,521

(22) Filed: May 20, 2005

(30) Foreign Application Priority Data
May 24, 2004 (JP) 2004-153379

(51) Int. Cl. H04B 1/16; H04M 1/00; H04B 1/38

(52) U.S. Cl. 455/343.1; 455/572

(57) ABSTRACT

A portable radio receiver with an automatic power generator has a ring-shaped receiver body, a coil, a magnetic material, a rechargeable battery and a receiver unit. The coil is wound in proximity to the receiver body. The magnetic material is movably located inside the coil. The rechargeable battery is provided for accumulating electric charge which is generated on the coil as the magnetic material moves. The receiver unit utilizes the rechargeable battery as a power source.

### FIELD OF THE INVENTION

The present invention relates to the field of radio receiver, specifically, the invention relates to a portable radio receiver which can be worn on a user's body.

### BACKGROUND OF THE INVENTION

Radio receivers are useful for information gathering when a disaster strikes. However, almost all radio receivers are not regularly used, and users are often oblivious of battery drain. Consequently, the radio receivers may be unavailable when needed. To solve the above problem, various radios having a power generator have been proposed.

Japanese unexamined patent publication No. 8-18466 discloses such a radio receiver. The radio receiver includes a coil contained in a cylindrical casing of the receiver and a permanent magnet located inside the coil for reciprocation therein. Then, a user is required to shake the casing up and down or right and left for electric power generation.

Additionally, Japanese unexamined patent publication No. 11-75344 also discloses such a radio receiver. The radio receiver has a foldable turning handle at the front face thereof. Then, a user is required to manipulate the turning handle for electric power generation.

Furthermore, Japanese unexamined patent publication No. 8-265889 further discloses such a radio receiver. The radio receiver is portable with a containable earphone, provided with a power generator for electric power generation through pulling out of the earphone.

The conventional radio receivers having a power generator require conscious manipulation for electric power generation, such as shaking a cylindrical body, turning the handle of a power generator, or pulling out an earphone, so that they are not automatic. Additionally, they also need a structure for electric power generation, so that their shapes are not easy to carry.

Furthermore, in the conventional technology, speakers are generally used as audio output means. However, there has been a problem in which electric power consumption for driving the speakers is large.

On the other hand, in the progress of semiconductor technology, conventional frequency modulation, or FM, or amplitude modulation, or AM, receiver circuits which require plural integrated circuits, or ICs, are replaced by a single integrated circuit, or IC. To miniaturize radio receivers, not only higher integration of the circuit but also smaller size of the antenna is required. One proposed solution includes an earphone utilized as an FM antenna. However, this requires users to use an earphone, and does not accommodate a users' desire to listen without using an earphone.

Furthermore, the conventional portable radio receivers require users to keep the receiver in their clothes' pockets or bags, so that they are not immediately accessible.

The present invention addresses a radio receiver which enables automatic power generation and is more portable and easily accessible. The present invention also addresses a portable radio receiver which enables listening without the use of an earphone. Furthermore, the present invention addresses a radio receiver which receives a transmission without an external antenna and is more compact.

### SUMMARY OF THE INVENTION

In accordance with the present invention, a portable radio receiver with an automatic power generator has a ring-shaped receiver body, a coil, a magnetic material, a rechargeable battery and a receiver unit. The coil is wound in proximity to the receiver body. The magnetic material is movably located inside the coil. The rechargeable battery is provided for accumulating electric charge which is generated on the coil as the magnetic material moves. The receiver unit utilizes the rechargeable battery as a power source.

In accordance with the present invention, a portable radio receiver with automatic power generator has a ring-shaped receiver body, a ring-shaped rotating member, a power generator, a rechargeable battery and a receiver unit. The ring-shaped rotating member is rotatably contained within the receiver body and provided with a portion which has a higher density than another portion of the rotating member. The generator is in contact with the rotating member and generates electric power as the rotating member rotates. The rechargeable battery is provided for accumulating electric charge generated by the power generator. The receiver unit utilizes the rechargeable battery as a power source.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1A is the structural view of a radio receiver according to a first embodiment of the present invention;

FIG. 1B is the enlarged schematic view of a receiver unit of the radio receiver according to a first embodiment of the present invention;

FIG. 2 is the structural view of a radio receiver according to a second embodiment of the present invention; and

FIG. 3 is the schematic view of a receiver unit of a radio receiver in which an audio output, or bone conduction speaker, is detachable from the receiver unit according to an alternative embodiment of the present invention.

### DETAILED DESCRIPTION OF THE PREFERRED EMBODIMENTS

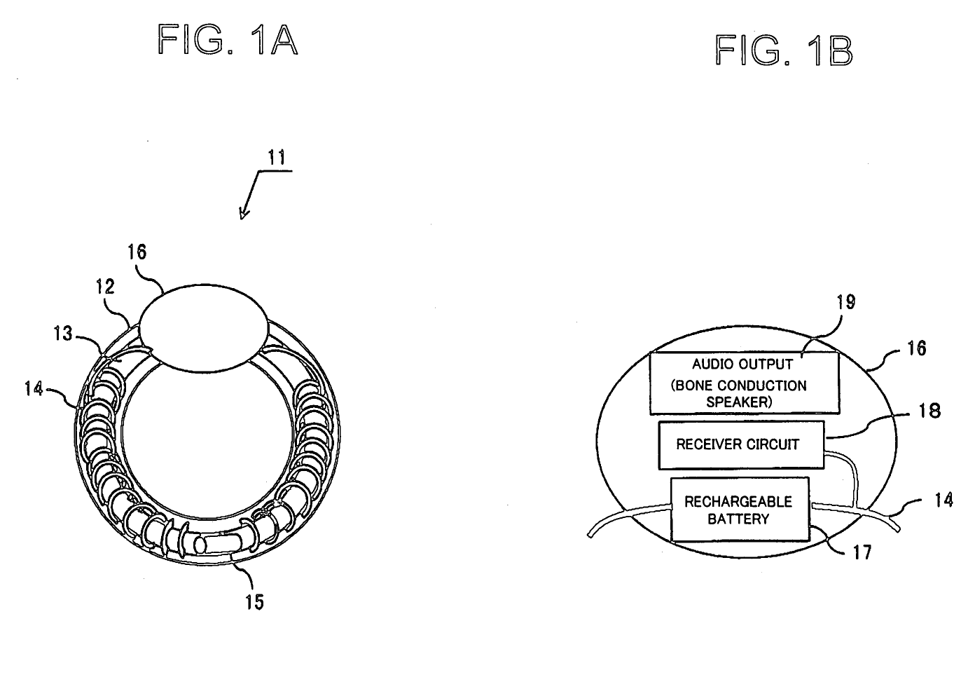

The following will describe a first embodiment according to the present invention with reference to FIGS. 1A and 1B. FIG. 1A illustrates the internal structure of a portable radio receiver 11 with automatic power generator (hereinafter, simply referred to as radio receiver) according to the first embodiment of the present invention. FIG. 1B illustrates the structure of a receiver unit 16 mounted on the radio receiver 11 according to the first embodiment of the present invention.

Referring to FIG. 1A, the radio receiver 11 includes a receiver body 12 and a receiver unit 16. The receiver body 12 having a ring shape is made of plastic material, or the like, and can be worn on user's body. The receiver body 12 is hollow inside and contains a hollow ring member 13 made of tubular plastic material, or the like. The receiver body 12, for example, has a shape similar to a bracelet which can be worn on user's arm or shape similar to a finger ring which can be worn on user's finger.

A coil 14 is wound in proximity to the ring member 13. In one embodiment, the coil 14 may be wound around the outer circumference of the ring member 13. A magnet (magnetic material) 15 is movably contained within the ring member 13. Both ends of the coil 14 are connected to a rechargeable battery or power source unit 17, including a capacitor device (not shown) such as a secondary battery. Voltage produced by the coil 14 is supplied to the rechargeable battery 17 for charging the rechargeable battery 17. One end of the coil 14 is also connected to a receiver circuit 18 to serve as an antenna. The receiver unit 16 includes the rechargeable battery 17, the receiver circuit 18, and a bone conduction speaker 19 as an audio output.

The following will describe the operation of the radio receiver 11.

When the user walks or does something with the receiver body 12 worn on the arm, the magnet 15 moves from side to side within coil 14 on the outer circumference of the ring member 13, with the result that voltage is generated between both ends of the coil 14 and then accumulated in the rechargeable battery 17 as electric power.

The receiver circuit 18, to which the coil 14 is connected as an antenna, receives FM airwaves by the coil 14 and amplifies them. The amplified signal is output as sound through the bone conduction speaker 19. Bringing the bone conduction speaker 19 into contact with the body near the ear allows the user to listen to the radio broadcast.

According to the first embodiment, by moving the body with the receiver body 12 worn on user's body, the rechargeable battery 17 of the radio receiver 11 may be charged regularly without any conscious manipulation for electric power generation.

Additionally, the radio receiver 11 having a wearable shape does not require the user to put it in a pocket, bag, or the like, to carry, with the result that it is more accessible. Furthermore, utilizing the coil 14 for electric power generation as an antenna not only makes an external antenna unnecessary but also allows the installation space of the coil 14 within the receiver body 12 to be used as the installation space of an antenna. Thus, space is effectively utilized. The application of the bone conduction speaker 19 makes it unnecessary to use an earphone, or the like, and improves usability in a compact form.

It is noted that in the first embodiment the coil 14 is wound around the outer circumference of the ring member 13 but another structure may be employed. For example, in one embodiment the receiver body 12 may be made of plastic material, or the like, and includes the insert coil 14. If the receiver body 12 forms a ring-shaped hole inside, and the ring-shaped hole movably contains the magnet 15, then, the ring member 13 is unnecessary.

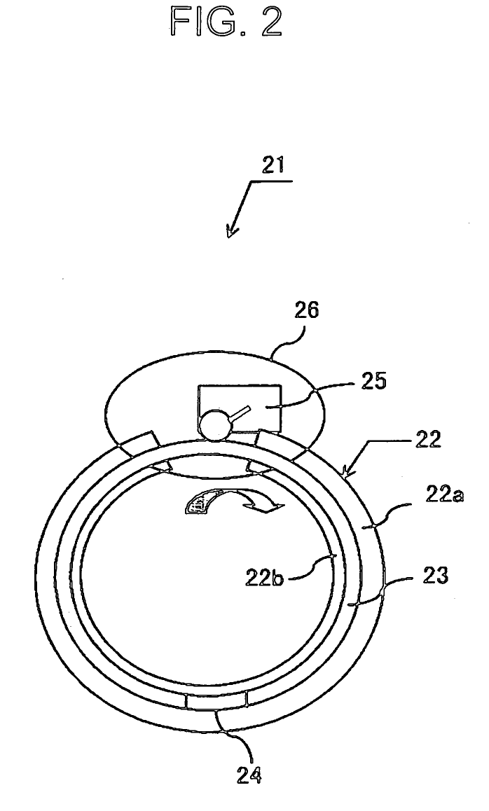

FIG. 2 is a view illustrating the internal structure of a portable radio receiver 21 with automatic power generator according to the second embodiment of the present invention. The second embodiment relates to a ring-shaped radio receiver 21 having a dynamo 25 for electric power generation.

The receiver body 22 may be made of plastic material, or the like, having a ring shape, and has formed therein a hollow space. The hollow space contains a ring (or rotating member) 23 which is made of plastic material, or the like, and rotatable in the hollow space. This ring 23 has an insert weight 24 made of conducting material such as metal which has a higher density than the plastic material. The ring 23 partially includes a heavy portion to bias the center of gravity of the ring 23, thereby allowing the ring 23 to easily rotate by its own weight. It is noted that a bearing (not shown), or the like, is provided between the receiver body 22 and the ring 23 to reduce damping of rotation of the ring 23 due to frictional force. The ring 23 is in contact with the dynamo (or power generator) 25. Therefore, the rotation of the ring 23 rotates the dynamo 25 for electric power generation.

A receiver unit 26, as well as the receiver unit 16 of FIG. 1B, includes the rechargeable battery or power source unit 17, the receiver circuit 18 and the bone conduction speaker 19.

The following will describe the operation of the radio receiver 21 according to the second embodiment of the present invention.

As the user waves the hand or does something with the receiver body 22 worn on the arm, or the like, a portion of the ring 23, or the insert weight 24, moves in a direction to reduce its potential energy. As a result, there produced torque on the ring 23, causing the dynamo 25 to generate electric power. In one embodiment, the dynamo 25 is a compact electrical generator that converts mechanical movement into electrical energy.

In use, as a user waves her hand while walking, the ring 23 swings from side to side and the dynamo 25 generates electric charge which is accumulated in the rechargeable battery 17.

According to the second embodiment, by moving the body with the receiver body 22 worn on user's body, the rechargeable battery 17 of the radio receiver 11 is charged regularly without any conscious manipulation for electric power generation. Additionally, the radio receiver 11 having a wearable shape does not require the user to put it in a pocket, bag, or the like, to carry, with the result that it is more easily accessible. The application of the bone conduction speaker 19 makes it unnecessary to use an earphone, or the like, and improves usability.

The following will describe a radio receiver according to a third embodiment of the present invention.

The radio receiver of the third embodiment includes the dynamo (or power generator) 25 of FIG. 2 and the coil 14 of FIG. 1A serving as an antenna. In the third embodiment, the receiver body 22 has formed therein a ring-shaped hole, and the ring 23 is contained in the ring-shaped hole. On the other hand, the outer circumference 22a or inner circumference 22b of the receiver body 22 has the insert coil 14. Alternatively, the receiver body 22 may be divisible into upper and lower members. The coil 14 is mounted inside the receiver body 22, and the ring 23 is then inserted.

According to the third embodiment, in addition to the advantages of the second embodiment, an external antenna is unnecessary by utilizing the coil 14 as an antenna. The installation space for a power generator may be utilized for the installation of an antenna, with the result that the inner space of the receiver body 22 may be used efficiently.

The present invention is not limited to the embodiments described above but may be modified into the following alternative embodiments.

(1) The present invention is not limited to a shape similar to a bracelet. One that has a ring-shaped and can be worn on user's body, such as finger rings, earrings, or the like, is applicable.

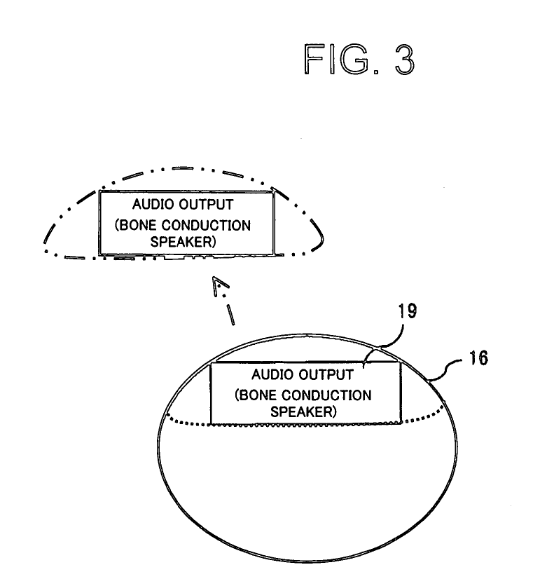

(2) The bone conduction speaker or audio output 19 is not limited to one fixed to the receiver unit. In an alternative embodiment as shown in FIG. 3, the bone conduction speaker 19 may be detachable from the receiver unit. In this case, the radio receiver may transmit signals to the bone conduction speaker 19 with short-range wireless communication.

Therefore, the present examples and embodiments are to be considered as illustrative and not restrictive. The invention is not to be limited to the embodiments described herein. It is to be understood that other similar embodiments may be used or modifications and additions may be made to the described embodiments for performing the same function. Therefore, the claimed invention should not be limited to any single embodiment, but rather should be construed in breadth and scope in accordance with the appended claims.

1. A portable radio receiver with an automatic power generator, comprising:
a ring-shaped receiver body;
a coil wound in proximity to the receiver body;
a magnetic material movably located inside the coil;
a rechargeable battery for accumulating electric charge which is generated on the coil as the magnetic material moves; and
a receiver unit utilizing the rechargeable battery as a power source.

2. The portable radio receiver according to claim 1, wherein the receiver unit utilizes the coil as an antenna.

3. The portable radio receiver according to claim 1, further comprising:
a hollow ring-shaped member, wherein the coil is wound around an outer circumference of the ring-shaped member, and wherein the magnetic material is movably contained within the ring-shaped member.

4. The portable radio receiver according to claim 1, wherein the receiver unit includes an audio output.

5. The portable radio receiver according to claim 4, wherein the audio output is a bone conduction speaker.

6. The portable radio receiver according to claim 4, wherein the audio output is detachable from receiver unit.

7. A portable radio receiver with an automatic power generator, comprising:
a ring-shaped receiver body;
a ring-shaped rotating member rotatably contained within the receiver body and provided with a portion which has a higher density than another portion of the rotating member;
a power generator in contact with the rotating member and generating electric power as the rotating member rotates;
a rechargeable battery for accumulating electric charge generated by the power generator; and
a receiver unit utilizing the rechargeable battery as a power source.

8. The portable radio receiver according to claim 7, further comprising:
a coil wound in proximity to the receiver body, wherein the receiver unit utilizes the coil as an antenna.

9. The portable radio receiver according to claim 7, wherein the receiver unit includes an audio output.

10. The portable radio receiver according to claim 9, wherein the audio output is a bone conduction speaker.

11. The portable radio receiver according to claim 9, wherein the audio output is detachable from the receiver unit.

12. The portable radio receiver according to claim 7, wherein the power generator is a dynamo.
